(19) United States
(12) Patent Application Publication
(10) Pub. No.: US 2025/0386222 A1
(43) Pub. Date: Dec. 18, 2025

(54) ENSURING GAPLESS MEASUREMENT FOR LOW-LATENCY CONNECTIONS

(71) Applicant: T-Mobile Innovations LLC, Overland Park, KS (US)

(72) Inventors: Anthony Punzal DEL ROSARIO, Sammamish, WA (US); Mehmet Hinc, Snoqualmie, WA (US)

(21) Appl. No.: 18/742,164

(22) Filed: Jun. 13, 2024

(51) Int. Cl. H04W 24/10

(52) U.S. Cl. CPC H04W 24/10

(57) ABSTRACT

Systems and methods are provided for ensuring gapless measurements for low-latency connections. Typically, a handover process includes a “gap measurement” to measure target cells' frequencies to identify a candidate cell to which a device should transfer. Low-latency connections cannot adequately perform with a “gap” in order to obtain the frequency measurements. Gapless measurements are provided in order to avoid the gap but present specific problems to devices that are configured for New Radio Carrier Aggregation (NR CA) as the device may not release a frequency band for measurements. By identifying NR CA-configured devices that need to undergo a handover and are involved in low-latency sessions, aspects herein can modify NR CA configurations temporarily to allow for gapless measurements for NR CA-configured devices.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for ensuring gapless measurements in 5G communications. More particularly, in aspects set forth herein, systems and methods enable gapless measurements in low-latency connections.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a flow diagram of a method for providing gapless measurements, in accordance with aspects herein;

FIG. 3 depicts a flow diagram of a method for providing gapless measurements, in accordance with aspects herein;

FIG. 4 depicts a flow diagram of a method for providing gapless measurements, in accordance with aspects herein; and

FIG. 5 depicts a diagram of an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
3GPP 3^{rd} Generation Partnership Project
4G Fourth-Generation Cellular Communication System
5G Fifth-Generation Cellular Communication System
CD-ROM Compact Disk Read Only Memory
CDMA Code Division Multiple Access
eNodeB Evolved Node B
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only
Memory
LED Light Emitting Diode
LTE Long Term Evolution
MIMO Multiple Input Multiple Output
MD Mobile Device
NR New Radio
NRCA NR Carrier Aggregation
PC Personal Computer
PCS Personal Communications Service
PDA Personal Digital Assistant
RAM Random Access Memory
RF Radio-Frequency
RFI Radio-Frequency Interference
R/N Relay Node
ROM Read Only Memory
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

The present disclosure is directed to ensuring gapless measurements for low-latency communications. In cellular communications, a geographical area is serviced by several cell sites (i.e., gNodeB), where each cell site serves a part of the geographical area. User equipment (UE) (e.g., mobile device, phone, etc.) that moves through the geographical area should be able to connect and communicate with the cell site that can provide the best connection/strongest signal in a particular location. When a signal strength is said to decline or degrade, it may become necessary to hand off the UE to another cell. This process is generally referred to as a handover. During handovers, when the current cell (e.g., source cell) has a different frequency than a neighbor cell (e.g., target cell), the current procedure is to cease/stop transfer of data to the UE (from the source cell) in order for the UE to retune its RF receiver to the target cells' frequency and then measure the received signals from the target cells to identify if any of the target cells are a candidate for handover of the UE. The tuning out of the source cell frequency to tune into the target cells' frequency to measure the signal quality of the target cells is referred to as a “measurement gap” or simply a “gap.”

During a gap, user data transfer between the UE and the source cell is not possible. However, recent 3GPP specifications allow the UE to measure target cell frequencies while still maintaining a connection to the source cell, enabling the UE to continue to send and/or receive data while measuring the RF signal of the target frequencies. This target frequency measurement can be referred to as a “gapless measurement.” One potential method to achieve such gapless measurements is to use multiple RF chains/bands in the UE such that one RF chain stays tuned into the source cell frequency (and is able to send and/or receive data) while the other RF chain(s) tunes to the target frequency to measures its RF signal.

Some applications and/or services require certain user-data transfer latency values (i.e., some applications/services require low-latency connections). Exemplary applications that require low-latency connections include real-time gaming, VR/AR, vehicle control (V2X communications), voice sessions, etc. To achieve the latency requirements, handovers need latency improvement especially when “gaps” are needed for RF signal measurements of target cells. Gapless measurements can mitigate or lessen the latency degradation while the UE is in target frequency measurement mode (i.e., when the UE is measuring the signal of target cells). However, the approach described above (i.e., utilizing multiple RF chains/bands) for gapless measurement introduces an issue with implementation of gapless measurement. In particular, utilizing multiple chains in New Radio Carrier Aggregation (NR CA) configurations may result in no free RF chain/band to tune to the target frequency to measure its RF signal. This can result when all RF chains are configured and/or active in transferring user-data as either a primary cell (PCell) or a secondary cell (SCell) of an NR CA connection. In that case, the benefits of gapless measurement cannot be realized as the UE will not release a band to enter target frequency measurement mode.

Accordingly, a first aspect of the present disclosure is directed to a system for providing gapless measurements. The system comprises one or more processors; and one or more computer-readable media storing computer-usable instructions that, when executed by the one or more processors, cause the one or more processors to: receive an indication of signal degradation; determine whether New Radio Carrier Aggregation (NR CA) is configured with any frequency band to be measured for a user equipment (UE); identify a first frequency band to be measured that has NR CA configuration; determine whether the UE is configured with one or more low-latency sessions; and upon determining that NR CA is configured with the first frequency band to be measured and that the UE is configured with one or more low-latency sessions, de-configure NR CA on the first frequency band.

A second aspect of the present disclosure is directed to a method for providing gapless measurements. The method comprises receiving an indication of signal degradation for a user equipment (UE); determining whether NR CA is configured with any frequency band to be measured; identifying a first frequency band to be measured that has NR CA configuration; determining whether the UE is configured with one or more low-latency sessions; and upon determining that NR CA is configured with the first frequency band to be measured and that the UE is configured with one or more low-latency sessions, de-configuring NR CA on the first frequency band.

Another aspect of the present disclosure is directed to a method for providing gapless measurements. The method comprises receiving, at a primary cell, an indication of signal degradation for a user equipment (UE); determining whether the UEs frequency bands are configured for New Radio Carrier Aggregation (NR CA); determining whether the UE is configured with one or more sessions associated with a low-latency 5G Quality of Service Indicator (5QI) value; upon determining that NR CA is configured for the UE frequency bands and that the UE is configured with one or more sessions associated with a low-latency 5GQI value, de-configuring NR CA on the at least one frequency band; communicating instructions to the UE comprising at least one target cell frequency to be measured; and receiving a measurement report comprising a signal quality of the target cell frequency, wherein a connection is maintained between the primary cell and the UE while target cell frequency measurements are obtained.

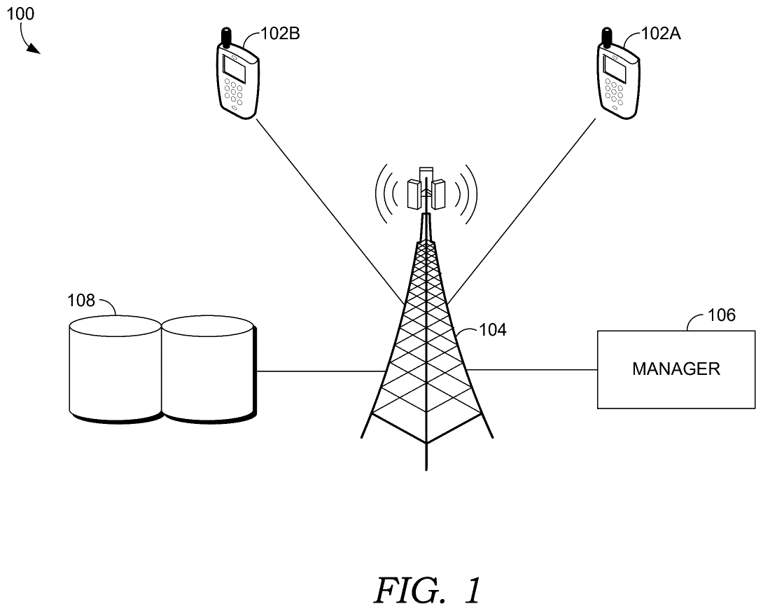

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

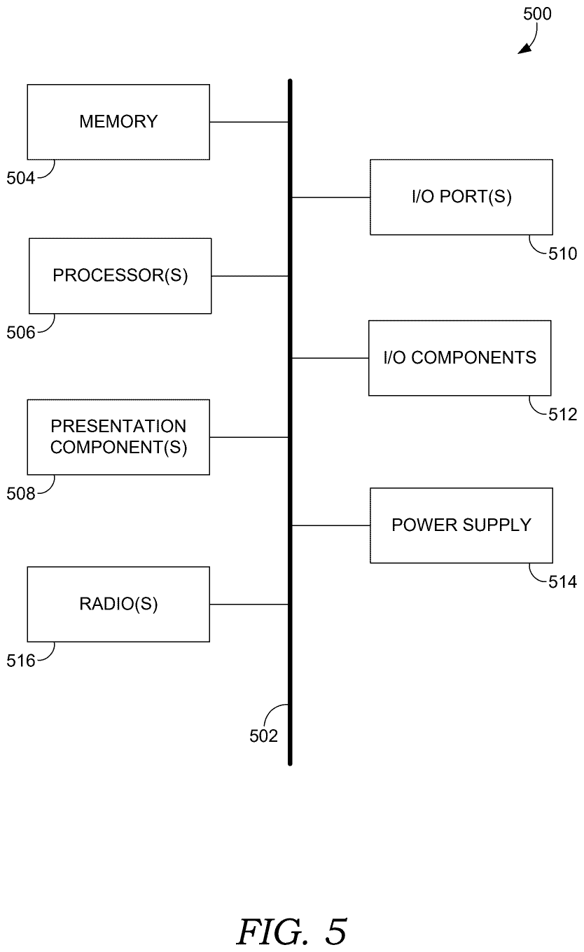

A network cell may comprise a base station to facilitate wireless communication between a communications device within the network cell, such as communications device 500 described with respect to FIG. 5, and a network. As shown in FIG. 1, communications device may be UE 102a and/or UE 102b. In the network environment 100, UE 102a and 102b may communicate with other devices, such as mobile devices, servers, etc. The UE 102a/102b may take on a variety of forms, such as a personal computer, a laptop computer, a tablet, a netbook, a mobile phone, a Smart phone, a personal digital assistant, or any other device capable of communicating with other devices. For example, the UE 102a/102b may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, 102a/102b comprises a wireless or mobile device with which a wireless telecommunication network(s) can be utilized for communication (e.g., voice and/or data communication). In this regard, the UE 102a/102b can be any mobile computing device that communicates by way of, for example, a 5G network.

The UE 102a/102b may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 102a/102b. For example, the network may provide voice services to user devices or corresponding users that are registered or subscribed to utilize the services provided by a telecommunications provider.

As shown in FIG. 1, the network 100 includes a cell 104 (may also be referred to as a node, cell site, gNodeB, etc.), a manager 106, and a database 108. Communication between the components (e.g., manager 106 and database 108) and cell 104 is clearly illustrated but is not exclusive of other communication routes. For example, UE 102A and database 108 may be in direct communication.

The database 108 is utilized by at least the cell 104 to store subscriber information, network information, and the like. In a 5G network, an exemplary storage component may be the Unified Data Function (UDF), which stores user subscription data and profiles and authentication credentials. Similarly, the Access Management Function (AMF) is responsible for managing the mobility of 5G devices, such as performing location tracking and handovers between different gNBs. Such network functions are not illustrated for simplicity, but are understood to be inherent in a 5G core network.

The manager 106 is provided herein to illustrate a controller for the mobility of 5G devices. The manager 106 may represent several network functions of a 5G core network. Particularly, the manager 106 is responsible for the control of mobility in the present invention. The network environment 100 illustrated in FIG. 1 ensures that a free RF chain/band is available to be used to measure the handover target frequency if all RF chains/bands are used by NR CA prior to the start of target frequency measurement.

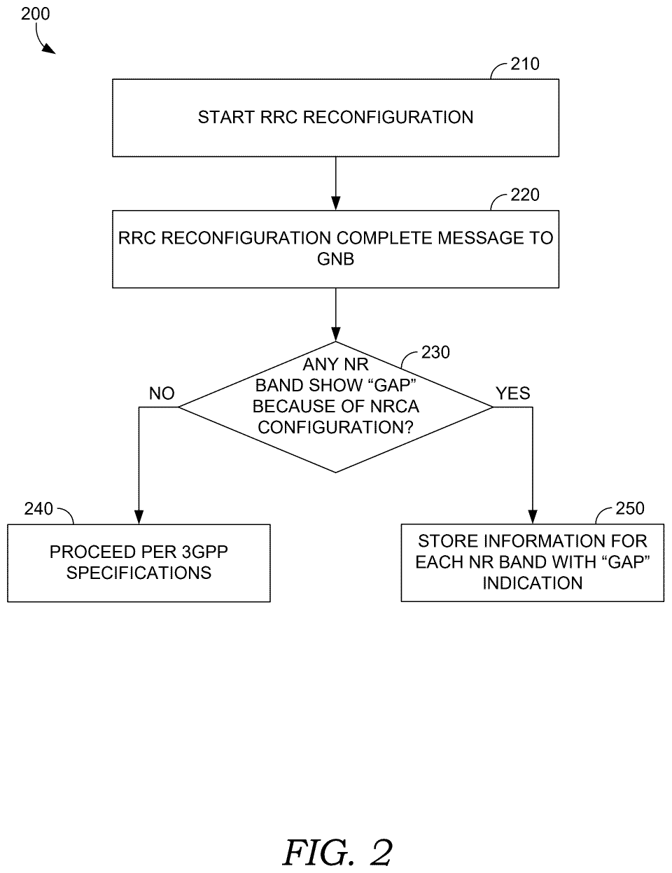

As shown in FIG. 2, an exemplary flow diagram 200 is provided illustrating a flow to provide gapless measurements. As is shown at block 210, a radio resource control (RRC) reconfiguration is initiated. A RRC reconfiguration procedure is used to establish, modify, or release radio connections between UEs and a network. A UE establishes an initial connection with a network, such as network 100, and both systems undergo a RRC reconfiguration. RRC reconfiguration can setup, modify, or release measurements, SCells, etc. RRC reconfiguration messages are communicated from the network to the UE to initiate the reconfiguration and an RRC configuration complete message is communicated from the UE to the network and is shown at block 220. The messages include a plurality of Information Elements (IEs). It is within the RRC configuration complete message where a UE can indicate if a gap or no gap is needed for RF measurements. The present solution offers additional details in the RRC configuration complete message such that a gap indicator is provided (e.g., gap required, gapless capable/no gap required) along with a reason indicator of why a gap is required if a gap is indicated as required by the gap indicator. Thus, the existing RRC reconfiguration complete message, which is a standard 3GPP message, can be modified to include information on a reason a certain band (frequency) needs a measurement gap. An exemplary reason discussed herein is being configured for NR CA, which could indicate that NR CA is active with that band. As shown in FIG. 2, a determination of whether any NR band shows “gap” (gap required) in the RRC reconfiguration complete message with NR CA configured provided as the reason for the gap required at block 230. If no gaps are required, the process proceeds at block 240 per 3GPP specifications. If, however, a gap is required for any of the bands due to NR CA configuration, the gap information for each band is stored (e.g., a reason for a gap) along with the gap indicator (e.g., whether or not gap is required). The stored information comprises a gap indicator for whether or not a gap is required and, if yes, additional gap data indicating a reason why the gap is required.

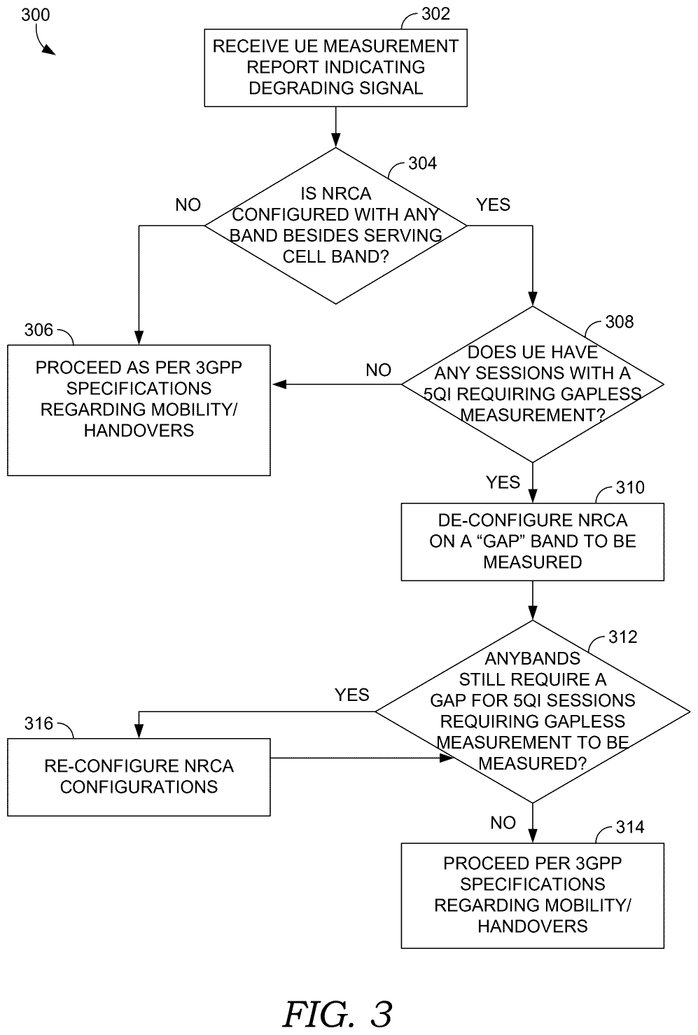

FIG. 3 provides an exemplary flow diagram 300 for illustrating a flow to provide gapless measurements. As described above and shown in FIG. 3, a measurement report indicating that a signal received by the UE (from a source cell or primary cell (PCell)) is degrading at block 302. A degrading signal may be indicated by a signal decreasing in strength lower than a predetermined threshold, a decrease in strength over a predetermined period of time, or a combination thereof. In order to ensure that gapless measurements are possible, the present method determines at block 304 whether NR CA is configured with any bands besides the serving cell band. As noted, if NR CA is not configured, multiple bands should be used to achieve gapless measurements in accordance with 3GPP specifications regarding mobility/handovers, as shown at block 306, without issue. However, if NR CA is configured, the UE may experience issues with entering target frequency measurement mode (i.e., when the UE is measuring signal frequencies of target cells) since the NR CA configuration may prevent any band from being released for measurements collection. The present invention can take action when NR CA is configured on a UE to ensure gapless measurements by de-configuring NR CA for at least one band such that at least one band can enter target frequency measurement mode. De-configuration, as used herein, refers generally to removing NR CA capabilities for a temporary period of time. However, signaling is a concern that should be evaluated by network providers and de-configuring NR CA for every UE having NR CA enabled would create more signaling than desired. Thus, the present invention includes a signaling safeguard and additional quality check to ensure that action is taken when appropriate. As shown at block 308, if NR CA is enabled, the method 300 further determines if the UE has any sessions with a 5G Quality of Service Indicator (5QI) value requiring gapless measurement. A 5QI value that requires gapless measurement is a 5QI value associated with a low-latency value under a predetermined latency threshold. In aspects, the predetermined latency threshold is less than 50 milliseconds. In other aspects, the predetermined latency threshold is less than 100 milliseconds. The predetermined latency threshold may be a configurable user configured parameter that determines when to implement the present invention.

If there are no sessions with a 5QI value requiring a gapless measurement, then the method should proceed at block 306 per 3GPP specifications regarding mobility/handovers in order to limit the amount of signaling created. Thus, if there are no sessions with a 5QI value requiring gapless measurements then NR CA will not be de-configured and, thus, no additional signaling from the NR CA de-configuration will be experienced.

If there are sessions with a 5QI value requiring gapless measurements, the method proceeds to block 310 and de-configures NR CA on any affected bands (i.e., bands that indicate gap required due to NR CA). In aspects, NR CA is de-configured for at least one frequency band indicating a gap is required due to NR CA. The bands can be de-configured by the gNB (source cell, PCell, etc.) using the existing RRC reconfiguration message (used to send the target frequencies to measure to the UE). Also, on the same RRC reconfiguration message, the measurement gap is removed and the Information Element (IE) is resent.

Subsequent to the de-configuration, an additional confirmatory check is performed at block 312 where an additional determination is performed to determine if any bands still require a gap for 5QI sessions requiring gapless measurement. If yes, the method 300 proceeds to block 316 where the NR CA configurations are re-configured. Otherwise, if no, the method 300 proceeds per 3GPP specifications regarding mobility/handovers at block 314. The additional confirmatory check can be the RRC reconfiguration complete message. If the UE responds to the RRC reconfiguration message with an RRC reconfiguration complete message that contains frequency bands that are still tagged as “gap”, the gNB may send an RRC reconfiguration message to re-install measurement gap configuration along with frequencies to measure and reconfigure NR CA of the affected bands as a mitigation to an unsuccessful procedure to get the UE to be able to do a gapless measurement. If successful with gapless measurement, the UE can be handed off to the target cell and NR CA is reconfigured according to the NR CA capabilities of the UE and the new serving gNB.

Thus, the present invention provides gapless measurements when NR CA is configured and a predetermined latency threshold is met with 5QI values. This provides gapless measurements in low-latency situations when needed and avoids additional re-configuration signaling/load (e.g., de-configuring NR CA) when low-latency is not needed. The gapless measurements allow for the UE to maintain communication with the source cell while designating other bands/chains for frequency measurement of target cells.

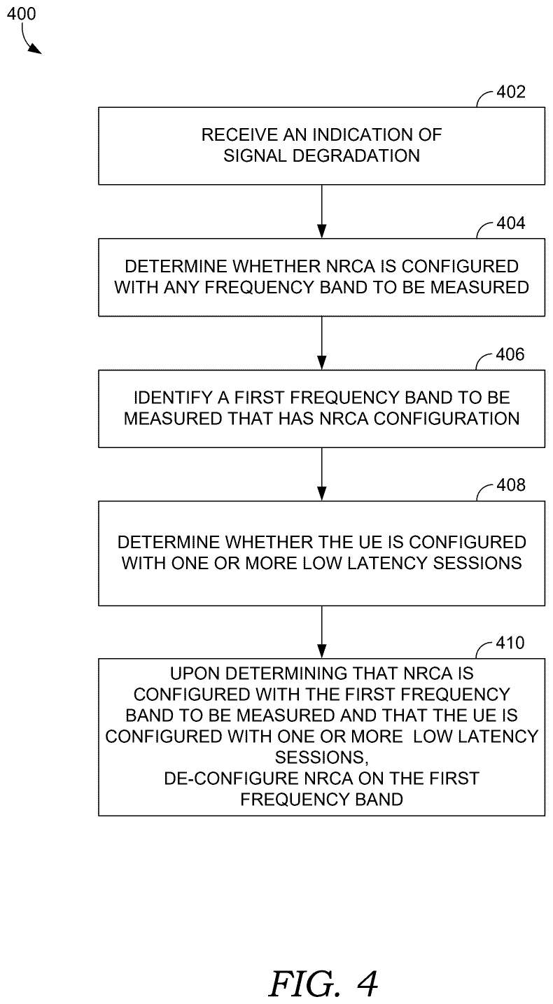

Referring to FIG. 4, a flow diagram 400 is provided illustrating a flow to provide gapless measurements. Initially, at block 402, an indication of signal degradation for a UE is received. At block 404, it is determined whether New Radio Carrier Aggregation (NR CA) is configured with any frequency band to be measured. At block 406, a first frequency band to be measured that has NR CA configuration is identified. It is then determined whether the UE is configured with one or more low-latency sessions at block 408. A low-latency session is defined herein according to a predetermined latency threshold that is dependent on a 5QI value. Upon determining that NR CA is configured with the first frequency band to be measured and that the UE is configured with one or more low-latency sessions, NR CA is de-configured for the first frequency band at block 410. In aspects, NR CA is de-configured for all affected bands having gaps required due to NR CA configuration. As discussed previously, the present invention avoids de-configuration of NR CA when measurements are not needed, or if measurements are needed with a gap for sessions not requiring gapless measurements (i.e., 5QI values that are higher than a predetermined latency threshold).

Referring to FIG. 5, a block diagram of an exemplary computing device 500 suitable for use in implementations of the technology described herein is provided. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. It should be noted that although some components in FIG. 5 are shown in the singular, they may be plural. For example, the computing device 500 might include multiple processors or multiple radios. In aspects, the computing device 500 may be a UE/WCD, or other user device, capable of two-way wireless communications with an access point. Some non-limiting examples of the computing device 500 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 5, computing device 500 includes a bus 502 that directly or indirectly couples various components together, including memory 504, processor(s) 506, presentation component(s) 508 (if applicable), radio(s) 516, input/output (I/O) port(s) 510, input/output (I/O) component(s) 512, and power supply(s) 514. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 512. Also, processors, such as one or more processors 506, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 504 may take the form of memory components described herein. Thus, further elaboration will not be provided here, but it should be noted that memory 504 may include any type of tangible medium that is capable of storing information, such as a database. A database may be any collection of records, data, and/or information. In one embodiment, memory 504 may include a set of embodied computer-executable instructions that, when executed, facilitate various functions or elements disclosed herein. These embodied instructions will variously be referred to as “instructions” or an “application” for short.

Processor 506 may actually be multiple processors that receive instructions and process them accordingly. Presentation component 508 may include a display, a speaker, and/or other components that may present information (e.g., a display, a screen, a lamp (LED), a graphical user interface (GUI), and/or even lighted keyboards) through visual, auditory, and/or other tactile cues.

Radio 516 represents a radio that facilitates communication with a wireless telecommunications network. Illustrative wireless telecommunications technologies include CDMA, GPRS, TDMA, GSM, and the like. Radio 516 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 516 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 510 may take a variety of forms. Exemplary I/O ports may include a USB jack, a stereo jack, an infrared port, a firewire port, other proprietary communications ports, and the like. Input/output (I/O) components 512 may comprise keyboards, microphones, speakers, touchscreens, and/or any other item usable to directly or indirectly input data into the computing device 500.

Power supply 514 may include batteries, fuel cells, and/or any other component that may act as a power source to supply power to the computing device 500 or to other network components, including through one or more electrical connections or couplings. Power supply 514 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for providing gapless measurements, the system comprising:
one or more processors; and
one or more computer-readable media storing computer-usable instructions that, when executed by the one or more processors, cause the one or more processors to:
receive an indication of signal degradation;
determine whether New Radio Carrier Aggregation (NR CA) is configured with any frequency band to be measured for a user equipment (UE);
identify a first frequency band to be measured that has NR CA configuration;
determine whether the UE is configured with one or more low-latency sessions; and
upon determining that NR CA is configured with the first frequency band to be measured and that the UE is configured with one or more low-latency sessions, de-configure NR CA on the first frequency band.

2. The system of claim 1, wherein signal degradation is a decline in signal strength below a predetermined threshold.

3. The system of claim 1, wherein the one or more low-latency sessions comprise a communication session having a latency value under a predetermined latency threshold.

4. The system of claim 1, wherein the one or more low-latency sessions comprise a communication session having a 5QI value indicating low-latency.

5. The system of claim 1, wherein NR CA is de-configured for any bands having NR CA configured.

6. The system of claim 1, wherein the processors further receive an indication of a gap indication from each frequency band of the user equipment.

7. The system of claim 6, wherein the gap indication comprises one of a gap required indication and a gapless indication.

8. A method for providing gapless measurements, the method comprising:
receiving an indication of signal degradation for a user equipment (UE);
determining whether New Radio Carrier Aggregation (NR CA) is configured with any frequency band to be measured;
identifying a first frequency band to be measured that has NR CA configuration;
determining whether the UE is configured with one or more low-latency sessions; and
upon determining that NR CA is configured with the first frequency band to be measured and that the UE is configured with one or more low-latency sessions, de-configuring NR CA on the first frequency band.

9. The method of claim 8, wherein signal degradation is a decline in signal strength below a predetermined threshold.

10. The method of claim 8, wherein the one or more low-latency sessions comprise a communication session having a latency value under a predetermined latency threshold.

11. The method of claim 8, wherein the one or more low-latency sessions comprise a communication session having a 5G Quality of Service Indicator (5QI) value indicating low-latency.

12. The method of claim 11, wherein the low-latency session is associated with a 5QI value of one of 5QI-1, 5QI-3, 5QI-80, and 5QI-82.

13. The method of claim 8, wherein NR CA is de-configured for any bands having NR CA configured.

14. The method of claim 8, further comprising receiving an indication of a gap indication from each frequency band of the user equipment.

15. The method of claim 14, wherein the gap indication comprises one of a gap required indication and a gapless indication.

16. The method of claim 8, further comprising:
receiving a measurement report; and
communicating an instruction to the UE to attach to a different source cell.

17. A method for providing gapless measurements, the method comprising:
receiving, at a primary cell, an indication of signal degradation for a user equipment (UE);
determining whether the UEs frequency bands are configured for New Radio Carrier Aggregation (NR CA);
determining whether the UE is configured with one or more sessions associated with a low-latency 5G Quality of Service Indicator (5QI) value;
upon determining that NR CA is configured for the UE frequency bands and that the UE is configured with one or more sessions associated with a low-latency 5GQI value, de-configuring NR CA on the at least one frequency band;
communicating instructions to the UE comprising at least one target cell frequency to be measured; and
receiving a measurement report comprising a signal quality of the target cell frequency,
wherein a connection is maintained between the primary cell and the UE while target cell frequency measurements are obtained.

18. The method of claim 17, wherein signal degradation is a decline in signal strength below a predetermined threshold.

19. The method of claim 18, further comprising communicating an instruction for the UE to handoff to the target cell frequency.

20. The method of claim 18, wherein the indication of signal degradation further comprises an indication that a gap is needed for frequency measurements and a reason the gap is needed.
